(19) United States
(12) Patent Application Publication
(10) Pub. No.: US 2026/0264988 A1
(43) Pub. Date: Sep. 10, 2026

(54) WEIGHING METHOD

(71) Applicant: AutoStore Technology AS, Nedre Vats (NO)

(72) Inventor: Staffan Hörnlund, Drammen (NO)

(21) Appl. No.: 18/868,973

(22) PCT Filed: May 30, 2023
(86) PCT No.: PCT/EP2023/064368

§ 371 Date: Nov. 25, 2024

(30) Foreign Application Priority Data
May 31, 2022 (NO) 20220625

(51) Int. Cl. B65G 1/137; B65G 1/04; G01G 19/08; G01G 19/42

(52) U.S. Cl. CPC B65G 1/1378; B65G 1/0464; G01G 19/08; G01G 19/42; B65G 2203/0241; B65G 2203/0258

(57) ABSTRACT

A method of weighing storage containers to determine the quantity of items in a storage container, in particular the number of items in a source storage container after the completion of a picking operation at a picking station that transfers items from the source storage container to a target container, for example to a delivery package.

### FIELD OF THE INVENTION

The present invention relates to an automated storage and retrieval system for storage and retrieval of containers, in particular to a method for the weighing of storage containers to determine the contents of the container.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station 406 where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

### Container Weighing

Many of the containers for storing and retrieving goods in the system described above contain a plurality of items. The weight of each individual item is a known variable, as is the weight of the container itself. It is thus possible to determine the number of items in a container by weighing the container. In practice, it is known to weigh a source storage container after a picking operation at a picking station as a control operation in order to confirm that the correct number of items were removed from the source storage container(S) and placed into a target container (T) by the operator. As used herein and in connection with the present invention, the term “picking station” means a workstation where a picker access the contents of a source storage container(S) in order to either remove one or more items or restock items into the container. The term picking station further should be understood to include the operative infrastructure immediately associated with the picking station, including for example conveyors, access doors, tipping devices and weighing devices. As used herein and in connection with the present invention, the term “target container” is any container to which items from the source container are transferred. An example of a target container is a delivery package. The term “picker” refers to either a human worker or an automated picking device.

The weight of source storage container(S) and the unit weight and number of items therein are known. Thus the initial weight of source storage container(S) prior to picking is known. At the picking station, a predetermined number of items of known weight is to be removed from(S) and transferred to (T). Thus, it is possible to determine the number of items removed by weighing source storage container(S) after the picking is completed. This operation is presently performed by a weighing device at the picking station immediately following/in connection with the picking operation, where an operator confirms that the source container(S) has the expected weight before source storage container(S) is sent away from the picking station and back to the stacks.

Performing the weighing at the picking station immediately following/in connection with a picking operation introduces a not-insignificant delay into the overall effectiveness of the storage and retrieval system however, due in part to a certain “lag” in the responsiveness of known weighing devices. In practice, the operator must wait an amount of time for the display of the weighing device to show the result of the weighing operation. If the weighing operation is automated, the system experiences a certain “lag” while the control system registers the weight. A picking operation is often performed in a small number of seconds, therefore the cumulative effect of even a small delay due to the weighing may be significant to the overall throughput of the system. Since the vast majority of picking operations are in fact performed correctly, the delay caused by weighing such correctly picked bins may be considered as wasted time.

### SUMMARY OF THE INVENTION

The present invention is set forth and characterized in the independent claims, while the dependent claims describe other characteristics of the invention.

In one aspect, the invention is related to a method for weighing storage containers to determine the quantity of items in a storage container, in particular the number of items in a source storage container after the completion of a picking operation at a picking station that transfers items from the source storage container to a target container, for example to a delivery package.

In one aspect, the method comprises weighing a source storage container(S) after the completion of a picking operation to determine the number of items therein. The weighing is performed at a time and/or location removed from the picking station and/or the picking operation, thus eliminating or ameliorating the negative consequences on throughput due to any time delay associated with a weighing operation. The control system chooses a time and/or location of the weighing operation that avoids or at least reduces any negative impact on throughput. As used herein, the term “at a time removed from a picking operation” is to be understood to mean an amount time such that the picking operation is completed to the degree that the source container(S) has been sent away from the picker such that a new picking operation can commence. In other words, an amount of time such that the actions and/or decision making of the picker is no longer affected by the weighing of the source container and a new picking operation may commence without regard to the weighing operation. As used herein, the term “at a location removed from the picking station” means a location a sufficient distance from the picking station that a new picking operation may commence without regard to the weighing operation.

Various non-limiting examples of the control system choosing a time and/or location for the weighing operation include:
Moving the source storage container to a buffer zone associated with the picking station (referred to as an “out buffer”) but delaying the weighing operation to a time calculated to have fewer negative consequences on throughput. The buffer zone will have a weighing device, for example a section of a conveyor having a weighing zone, or a weighing device adjacent to a conveyor, onto which the source container is pushed.
Moving the source container to a separate staging area having a weighing device similar to that described above, physically distant from the picking station, the staging area being a location where source containers await transport back to the stacks
Weighing the source container on an automated vehicle equipped with a weighing device while the source container is in transit away from the picking station.

According to an aspect of the method, the control system of the storage and retrieval system records a “dependency” between a storage container S and a target container T into which items from S are to be transferred. The term “dependency” means any form for conceptual, temporary association between source container(S) and target container (T). Such dependency may be computer implemented, for example recorded in memory or otherwise implemented by control system 500 by means known in the art of computerized control systems.

The “dependency” between S and T includes information on the number of items intended to be removed from S and placed in T, as well as an expected weight of S after the picking operation. In one aspect, the expected weight of S is expressed as an expected weight range. The range may be a based on a percentage to account for slight deviations or errors in weighing. In another aspect the weight range may be based on a statistical variation in the weight of individual items, for example weight variations for a particular vegetable or fruit and the like. For example such items having variable weight could be assigned a standard weight, the weight range taking into account statistical deviations from the standard weight for individual items.

The recording of the dependency is an automated step causing no delay in the picking operation.

A given target container (T) may have multiple dependencies from multiple different source containers(S).

While the source container(S) is moved after the picking operation to the location where it is to be weighed, target delivery container (T) is sent to a destination. One example of a destination is a delivery staging area in preparation for final delivery. An example of a delivery staging area is a dedicated space at or near a loading dock where delivery containers are loaded onto delivery trucks. Alternatively, the delivery staging area may be a storage room, or a designated section of the storage grid. Target container (T) waits either while in transit or while located at the destination, for example in the delivery staging area, for the results of the weighing operation on the one or more source storage containers(S) upon which it depends.

If, when S is eventually weighed, the weight is within the expected range (which statistically is the vast majority of cases) then the “dependency” between T and S is removed and T is “cleared” to continue its delivery routine, for example cleared to be loaded onto the delivery truck. In one embodiment, target container T may comprise a bar code, Q code or other machine-readable code that permits delivery personnel to scan the code of delivery containers to ascertain that the containers are cleared for loading onto the truck. Source storage container(S) is similarly “cleared” to be returned to the stacks, with its new weight recorded by the control system.

If, however the weight of S is unexpected, (i.e. outside the expected range), then both S and T are marked or “flagged” for manual inspection and corrective repackaging if needed. In one aspect, storage container S and/or target container T may be transported to a dedicated location for inspection. In another aspect S and/or T may be inspected at their respective staging areas.

As can be appreciated, the present invention eliminates or at least ameliorates any delay caused by the weighing operation by decoupling the weighing operation from the picking operation, and preforming the weighing operation at a time or location that has less negative effect on throughput.

According to another aspect of the invention, target container (T) may be weighed as a further control of the picking operation, for example weighed at the delivery staging area. In this aspect, the control system may compare the results of the weighing operation of both source container(S) and target container (T) to confirm that the number of items removed from(S) have in fact been placed in (T). Such comparison could be important for example where the items are of high value and there exists a danger of theft or misplacement of items.

According to one aspect, the present invention comprises:
A method for weighing storage containers in an automated storage and retrieval system to determine the quantity of items in the storage containers, in particular the number of items in a source storage container(S) after the completion of a picking operation that transfers items from the source storage container(S) to a target container (T), the automated storage and retrieval system comprising automated vehicles adapted for removing storage containers from and replacing storage containers into storage stacks as well as transporting said storage containers, and a picking station where a picker transfers items from the source storage container(S) to the target container (T), the method comprising the steps of:
   a. transporting the source storage container(S) to the picking station,
   b. transferring a predetermined number of items from the source storage container(S) to the target container (T),
   c. establishing a post-transfer expected weight range for the source storage container, the expected weight range being based on the number of items of known weight intended to be transferred into the target container,
   d. recording a dependency between the source storage container and the target container,
   e. transporting the source storage container to a weighing location,
   f. transporting the target container to a delivery staging area,
   g. weighing the source storage container to obtain a weight of the source storage container and any remaining items in the storage container, the weighing of the source container occurring at a time removed from the picking operation,
   h. determining from the weight of the source storage container and any remaining items in the source storage container whether the weight is within the expected weight range, and:
      (a) if the weight is within the expected weight range, removing the dependency between the source storage container and the target container, thereby clearing the source storage container for return to the storage stacks and clearing the target container for delivery to an intended destination, or
      (b) if the weight is outside the expected weight range, flagging the source storage container and target container for inspection, and if required, for corrective repackaging.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a prior art picking station

FIG. 6 is a diagram illustrating steps in an embodiment of the invention.

FIG. 7 is a diagram illustrating an embodiment of the invention

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

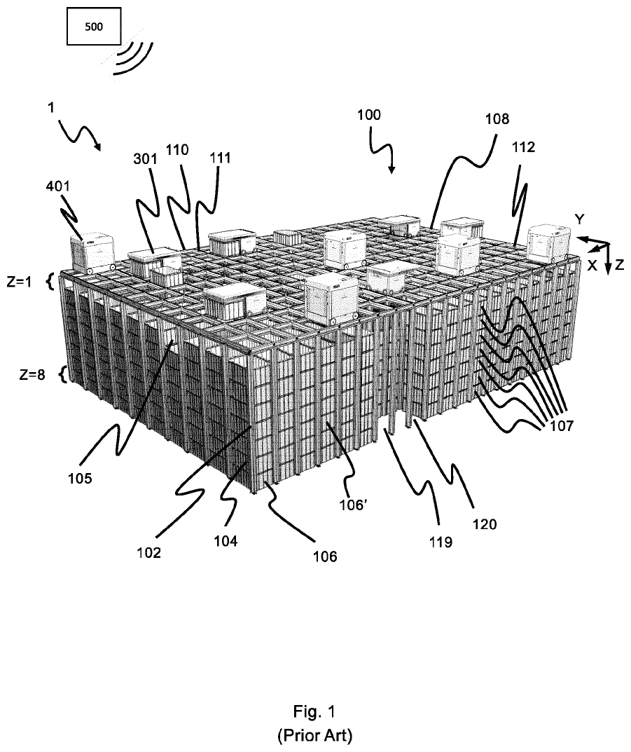

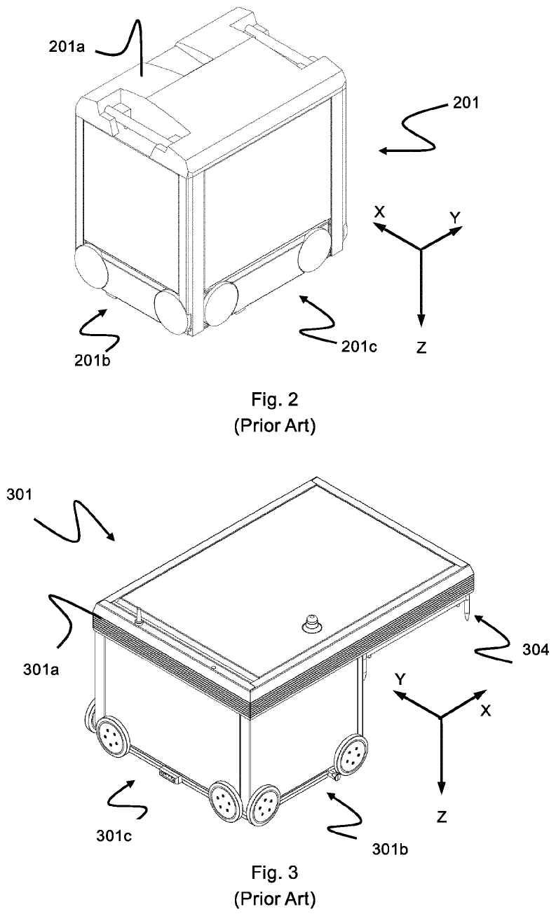

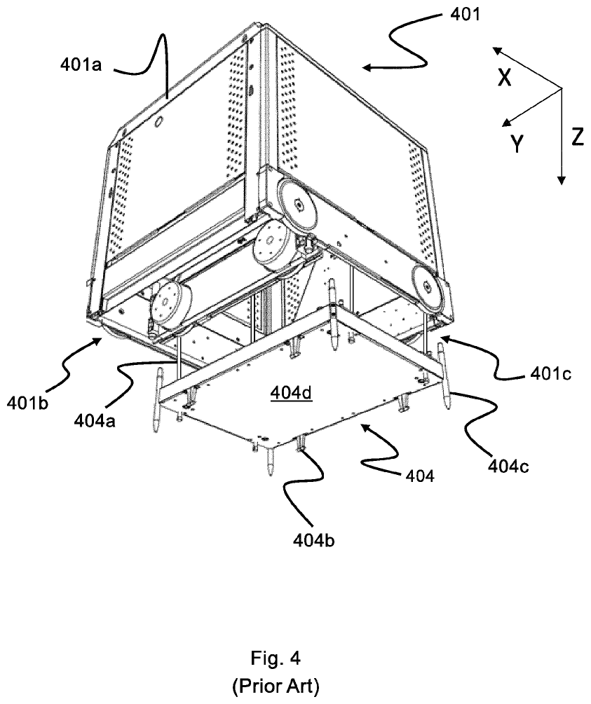

The present invention comprises, and is employed in connection with, an automated storage and retrieval system as described in the background section of this application. A framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

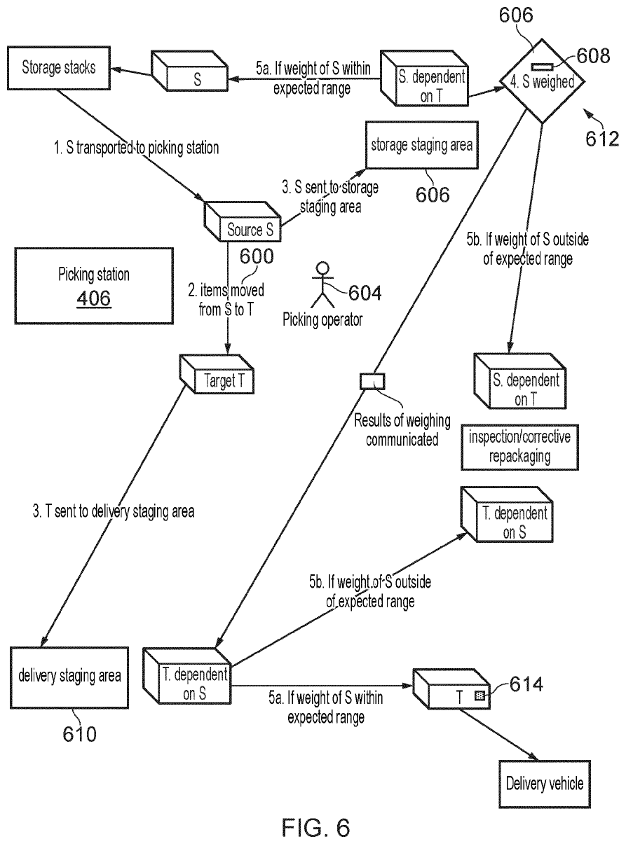

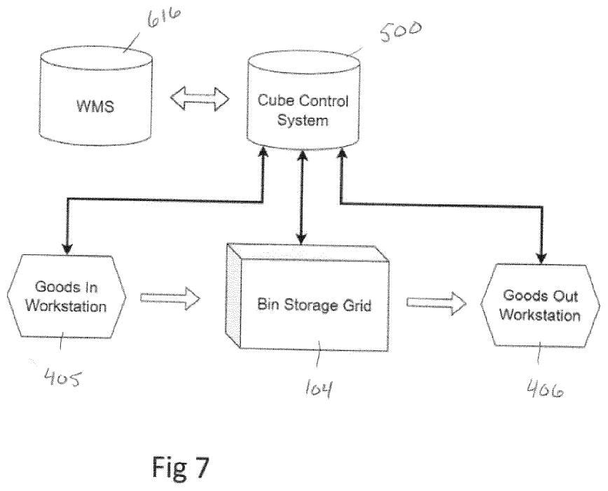

One embodiment of the invention, for use in an automated storage and retrieval system according to the invention will now be discussed in more detail with reference to FIGS. 6 and 7.

In the preceding description, various aspects of the invention have been described with reference to the illustrative embodiment(s). For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

According to one aspect, the invention provides a method for weighing storage containers in an automated storage and retrieval system to determine the quantity of items in the storage containers, in particular the number of items in a source storage container(S) after the completion of a picking operation that transfers items from the source storage container(S) to a target container (T).

According to an embodiment of the method, the control system 500 of the automated storage and retrieval system initiates a delivery sequence wherein one or more items are to be transferred from one or more source storage containers(S) to a target container (T). An example of such a delivery sequence is the fulfillment of a customer order, where items comprising the order are to be transferred to a delivery package. It is to be understood, however, that such a delivery sequence also encompasses any other transfer of items from a source container to a target container for other purposes, such as for restocking or reorganizing the contents of storage containers. For the simplicity, the invention will be described in the context of items transferred to a delivery package, however one skilled in the art will be able to extrapolate the steps of the invention for other purposes.

According to an embodiment of the invention, a source storage container(S) is transported from a stack 107 to a picking station 406. The source storage container may be transported by automated vehicles, by conveyors, through ports, or any combination of the above or by other means. The weight of source container(S) is a known quantity and is recorded by the control system 500. The weight and number of individual items contained within source container(S) is also a known quantity and is recorded by control system 500. Control system 500 further records information related to a picking operation 600. The information includes the number of items intended to be transferred to target container (T). Control system 500 further records an expected weight 602 that source container(S) will have after the picking operation 600 has been completed. Expected weight 602 may be a single numerical value or may be a weight range.

At picking station 406, a picker 604 transfers items from source container(S) to target container (T). Picker 604 may be a human picking operator or may be an automated picking device.

Control system 500 records a “dependency” between source container(S) and target container (T). As used herein, the term “dependency” means any form for conceptual, temporary association between source container(S) and target container (T). In one aspect the dependency is a computer implemented association. Such dependency may be recorded in memory or otherwise implemented by control system 500 by means known in the art of computerized control systems. It is to be understood that items from a plurality of source containers may be added to target container (T), thereby resulting in target container (T) having multiple dependencies. For simplicity, the invention will be described in connection with a single dependency between a single source container and a single target container.

After the transfer of items is completed, source container(S) is transported to a weighing location 606 comprising a weighing device 608. Weighing location 606 may be an area adjacent to or physically distant from the picking station. For example, the weighing location may be an area adjacent to the picking station designated as an “out buffer” where storage containers await transport back to stacks 107. Alternatively, weighing location 606 may be a dedicated storage staging area physically distant from the picking station, where storage containers await transport back to the stacks. Alternatively, the weighing location may be aboard an automated transport vehicle comprising a weighing device 608. In connection with an “out buffer” or “staging area” weighing location, the weighing device 608 may for example be integrated into a section of a conveyor belt, or may be adjacent to a conveyor belt with a pushing device that pushes the container onto the weighing device.

After the transfer of items, transfer container (T) is transported to a delivery staging area 610. The term “delivery staging area” as used herein means any designated location where target container (T) is located while it awaits the results of a weighing operation 612, discussed below. Non-limiting examples of delivery staging areas include a dedicated space at or near a loading dock where delivery containers are loaded onto delivery trucks. Alternatively, the delivery staging area may be a storage room, or a designated section of the storage grid.

At weighing location 606, a weighing operation 612 is performed on source container(S). The weighing operation is performed at a time removed from the picking operation 600. As used herein, the term “at a time removed from a picking operation” is to be understood to mean an amount time such that the picking operation is completed to the degree that the source container(S) has been sent away from the picker such that a new picking operation can commence. In other words, an amount of time such that the actions and/or decision making of the picker is no longer affected by the weighing of the source container and a new picking operation may commence without regard to the weighing operation. In one aspect, control system 500 calculates and determines the time of the weighing operation based on information related to the throughput of the storage and retrieval system, determining a time based on factors intended to eliminate or ameliorate reduced throughput caused by any delays associated with the weighing operation 612. In another aspect, “a time removed from a picking operation” is an inherent consequence of the weighing location 606 being physically distant from the picking station 600.

If, when S is eventually weighed in weighing operation 612, the weight is within the expected range (which statistically is the vast majority of cases) then the “dependency” between T and S is removed and T is “cleared” to continue its delivery routine, for example cleared to be loaded onto a delivery truck. In one embodiment, target container T may comprise a bar code, Q code or other machine-readable code 614 that permits delivery personnel to scan the code of delivery containers to ascertain that the containers are cleared for loading onto the truck. Source storage container(S) is similarly “cleared” to be returned to the stacks, with its new weight recorded by the control system.

If, however the weight of S is unexpected, (i.e. outside the expected range), then both S and T are marked or “flagged” for manual inspection and corrective repackaging if needed. In one aspect, storage container S and/or target container T may be transported to a dedicated location for inspection. In another aspect S and/or T may be inspected at their respective staging areas.

According to another aspect of the invention, target container (T) may be weighed as a further control of the picking operation, for example weighed at the delivery staging area. In this aspect, the control system may compare the results of the weighing operation of both source container(S) and target container (T) to confirm that the number of items removed from(S) have in fact been placed in (T). Such comparison could be important for example where the items are of high value and there exists a danger of theft or misplacement of items.

According to another aspect, the invention comprises a computer program product comprising instructions that when executed on a control system 500 for an automated storage and retrieval system performs the method of weighing storage containers to determine the quantity of items in a storage container, in particular the number of items in a source storage container after the completion of a picking operation at a picking station that transfers items from the source storage container to a target container, for example to a delivery package.

According to this aspect of the invention, a number of terms are defined below:

### Definitions

| Name | Description |
|---|---|
| CBS | Cube Based Storage. An alternative name used to |
| | identify an automated storage and retrieval system as |
| | described in the background section, and as used in |
| | the description of the present invention. |
| SKU | Stock Keeping Unit. This is a well-known term of art, |
| | used to identify an item that a warehouse is storing. |
| | It can for example be a black T-shirt of a specific |
| | brand and size, one model of a phone, and so on. |
| Bin | An alternative name for a storage container in the |
| | CBS. A bin can contain one or more type of SKU and |
| | any number of these, a Customer bin (described below) |
| | or a combination of the two. |
| Customer bin | A storage container that is used outside the CBS, but |
| | that can be stored in a bin. A customer bin might |
| | contain one or more type of SKU and any number of |
| | these, or finished packed orders in packaging. Note |
| | that the physical container might be a plastic bin, |
| | paper bag, cardboard box, etc., all depending on the |
| | particular installation. |
| WMS | Warehouse Management System. This is a system that |
| | keeps track of the inventory of the warehouse, the |
| | orders placed, the time trucks arrive/leave, and all |
| | other information that a warehouse uses. The WMS |
| | integrates with the CBS to know which SKU is in which |
| | bin and how many of them there are. |
| CCS | Cube Control System. This is the system that runs the |
| | CBS by keeping track of the location and data of the |
| | bins and by controlling the machinery involved such |
| | as the automated vehicles of the system. |
| | The WMS and the CCS may be separate systems, or |
| | integrated into a single control system for the |
| | automated storage and retrieval system. |
| Source bin | An alternative name for a source storage container |
| | (S). When a bin in a CBS is used in a picking |
| | process, i.e. to collect a number of SKUs for an |
| | order, these bins are called “source bins”. |
| Target bin | An alternative name for a target storage container |
| | (T). When SKUs are picked from a source bin, the |
| | place that they are picked to is called the “target |
| | bin”. This can be a bin or a customer bin, as defined |
| | above. |
| Workstation | When bins are inserted into a CBS, goods are inserted |
| | into bins of a CBS, or goods are picked in a CBS, |
| | this is done at a workstation. This is a location |
| | that might contain mechanical parts and that allows |
| | human or robot pickers to interact with the bins of |
| | the CBS. |
| | The workstations can be dedicated for inserting bins, |
| | performing a “goods in” operation, for performing |
| | picking operations, or support a combination of them. |
| | The term “workstation” is to be understood to be a |
| | generic term that encompasses the term “picking |
| | station” as used in this application. Depending upon |
| | the context, the terms “picking station” may |
| | encompass the functions of a “goods in” work station” |
| | and/or “goods out workstation” as described below. |
| Goods In | A workstation for performing a “goods in” operation |
| Workstation | where bins are filled with SKUs. |
| Goods Out | A workstation for performing a picking operation |
| Workstation | where SKUs are picked from bins. |

According to an aspect of the invention, a Cube Based Storage comprises a Warehouse Management System (WMS) 616 arranged to communicates with the Cube Control System 500 to keep track of which bins the Stock Keeping Units (SKUs) are located in.

The invention according to one aspect comprises the following distinct functions. They may be run at different locations and different times and may be implemented through storing data in the CCS. The end output is a list of storage bins that need to be manually checked before being stored in the CBS.

```
struct PickInfo:
  The Bin ID id,
  Number of SKUs to pick n,
  Weight per invidiual SKU to pick w
struct BinInfo:
  The Bin ID id,
  The weight of the bin w
CCS contains the following data:
  List of BinInfo with all bins in the system bins,
  List of Bin ID that require weighing uw,
  Allowed weight difference diff_weight,
  HashMap with Bin ID as key and a List of Bin ID as value which map
  the bins that a target bin depends on dep
  List of Bin ID for bins that need to be manually checked need_check
function goodsInserted:
  input:
    BinInfo from bins of the bin where goods have been inserted bin,
    Weight of the bin after goods have been inserted w
  This function is run when goods are inserted
  bin.w ← w
function goodsPicking:
  input:
    Target bin t,
    List of PickInfo of so|urce bins sources
  This function is run when goods are picked from a workstation.
  CCS.dep.Insert(t)
  For each s in sources when presented in the workstation do:
    CCS.uw.Append(s)
    CCS.dep[t].Append(s.id)
function binWeighing:
  input:
    A Source bin PickInfo that should be weighted after being presented in
    the workstation s_pickinfo
  This function is run for each bin in CCS.uw
  s ← CCS.bins[s_pickinfo.id]
  old_weight ← s.weight
  s.weight ← weight(s.id)
  difference ← old_weight − s.weight
  expected_difference ← old_weight
      − s_pickinfo.n * s_pickinfo.w
  if abs(expected_difference − difference) > CCS.diff_weight do
    CCS.need_check.Append(s.id)
    CCS.need_check.Append(getTargetBinFromSourceBin(s.id))
```

### LIST OF REFERENCE NUMBERS

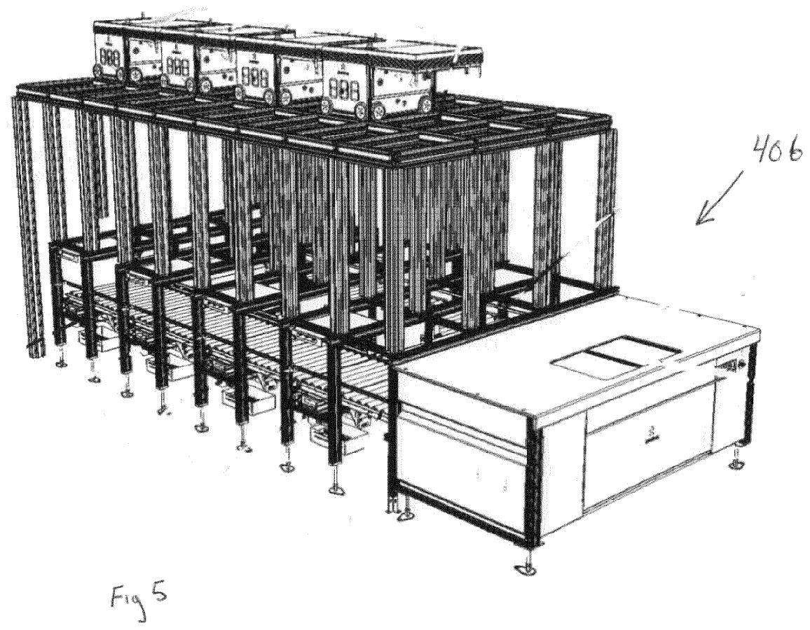

### Prior Art (FIGS. 1-5)

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
405 Goods in workstation
406 Picking station or “goods out” workstation
500 Control system
X First direction
Y Second direction
Z Third direction
600 Picking operation
602 Expected weight
604 Picker
606 Weighing location
608 Weighing device
610 Delivery staging area
612 Weighing operation
614 Machine readable code
616 Warehouse management system

1.-8. (canceled)

9. A method for weighing storage containers in an automated storage and retrieval system to determine a quantity of items in the storage containers, in particular a number of items in a source storage container after completion of a picking operation that transfers the items from the source storage container to a target container, the automated storage and retrieval system comprising automated vehicles adapted for removing the storage containers from and replacing the storage containers into storage stacks as well as transporting the storage containers, and a picking station, wherein a picker transfers the items from the source storage container to the target container, the method comprising the steps of:
transporting the source storage container to the picking station;
transferring a predetermined number of items from the source storage container to the target container;
establishing a post-transfer expected weight range for the source storage container, the post-transfer expected weight range being based on the number of items of known weight intended to be transferred into the target container;
recording a dependency between the source storage container and the target container;
transporting the source storage container to a weighing location;
transporting the target container to a delivery staging area;
weighing the source storage container to obtain a weight of the source storage container and any remaining items in the source storage container, wherein weighing the source storage container occurs at a time removed from the picking operation; and
determining from the weight of the source storage container and any remaining items in the source storage container whether the weight is within the post-transfer expected weight range, and:
if the weight is within the post-transfer expected weight range, removing the dependency between the source storage container and the target container, thereby clearing the source storage container for return to the storage stacks and clearing the target container for delivery to an intended destination, or
if the weight is outside the post-transfer expected weight range, flagging the source storage container and the target container for inspection, and if required, for corrective repackaging.

10. The method of claim 9, wherein items from a plurality of source storage containers are transferred into the target container, the target container having a dependency to each of the plurality of source storage containers that must be removed prior to the target container being cleared for the delivery.

11. The method of claim 9, wherein the weighing location is an area adjacent to the picking station designated as an out buffer.

12. The method of claim 9, wherein the weighing location is a staging area physically distant from the picking station.

13. The method of claim 9, wherein the weighing location is on board an automated transport vehicle.

14. An automated storage and retrieval system comprising: automated vehicles adapted for removing storage containers from and replacing the storage containers into storage stacks as well as transporting the storage containers; a picking station, wherein a picker is configured to transfer items from a source storage container to a target container; and a computing device operating a control system of the automated storage and retrieval system, wherein the computing device is configured to perform instructions stored on a computer program product that direct the performance of the method of claim 9.

15. Computer program product for an automated storage and retrieval system, wherein the computer program product comprises instructions that, when performed on a computing device operating a control system of the automated storage and retrieval system, direct the performance of the method of claim 9.

16. The computer program product of claim 15, wherein the instructions comprise:
struct PickInfo:
The Bin ID id,
Number of SKUs to pick n,
Weight per individual SKU to pick w
struct BinInfo:
The Bin ID id,
The weight of the bin w
CCS contains the following data:
List of BinInfo with all bins in the system bins,
List of Bin ID that require weighing uw,
Allowed weight difference diff_weight,
HashMap with Bin ID as key and a List of Bin ID as value which map the bins that a target bin depends on dep
List of Bin ID for bins that need to be manually checked need_check
function goodsInserted:
input:
BinInfo from bins of the bin where goods have been inserted bin,
Weight of the bin after goods have been inserted w
This function is run when goods are inserted
bin.w←W
function goodsPicking:
input:
Target bin t,
List of PickInfo of source bins sources
This function is run when goods are picked from a workstation.
CCS.dep.Insert(t)
For each s in sources when presented in the workstation do:
CCS.uw.Append(s)
CCS.dep[t].Append(s.id)
function binWeighing:
input:
A Source bin Pickinfo that should be weighed after being presented in the workstation s_pickinfo
This function is run for each bin in CCS.uw
S←CCS.bins[s_pickinfo.id]
old_weight←s.weight
s.weight←weight(s.id)
difference←old_weight−s.weight
expected_difference←old_weight−s_pickinfo.n*s_pickinfo.w
if abs(expected_difference−difference)>CCS.ditt_weight do CCS.need_check.Append(s.id) CCS.need_check.Append(getTargetBinFromSourceBin(s.id))
